(19) United States
(12) Patent Application Publication
(10) Pub. No.: US 2003/0037065 A1
(43) Pub. Date: Feb. 20, 2003

(54) Method and apparatus for using medical ID smart card

(76) Inventor: Alena Svab, Wayne, NJ (US)

Correspondence Address: BIRCH STEWART KOLASCH & BIRCH, PO BOX 747, FALLS CHURCH, VA, 22040-0747, US

(21) Appl. No.: 10/207,204

(22) Filed: Jul. 30, 2002

Related U.S. Application Data
(60) Provisional application No. 60/308,106, filed on Jul. 30, 2001.

(51) Int. Cl. G06F 7/00

(52) U.S. Cl. 707/104.1

(57) ABSTRACT

A personalized smart card is encoded with medical patient information, including patient identification, and a Uniform Resource Locator (URL) of an insurance provider's and/or pharmaceutical service provider's extranet or a web site to facilitate health care insurance transactions and administration. In one implementation, a computer-implemented method uses such a smart card to provide digital ID, data storage and automatic navigation to a web or extranet site and/or issuer database. An authorized member of medical, health or other organization inserts the smart card into a smart card reader that is connected to a computer or other computing device capable of accessing the web, extranet or a targeted database. An exchange of an encryption formula, card media vs. reader/writer occurs prior to a response from the system host device. After encryption is verified, an access to the particular server is allowed. In response to the insertion of the smart card into the smart card reader, an issuer specific program and/or a browser is launched. As a result, the authorized user may automatically navigate to the targeted site simply by inserting the smart card into the smart card reader, without having to type any information, use the computer's mouse, or provide any other user input.

### CROSS-REFERENCE TO RELATED APPLICATION

This application claims priority under 35 U.S.C. §119(e) of U.S. Provisional Application No. 60/308,106 filed on Jul. 30, 2001, the entire contents of which are herein incorporated by reference.

### BACKGROUND

1. Field of the Invention

The present invention relates to techniques for medical identification, health care administration, and pharmaceutical services. More particularly, the present invention relates to a technique for using a smart card to identify a patient and navigate to a health insurance provider's and/or a pharmaceutical service provider's extranet (web site for targeted users) or a regular public web site for medical insurance coverage details and/or pharmaceutical services, as well as encoding vital personal data to the card media. The invention has particular significance and applicability to the U.S. healthcare system, but is also suitable for global applications.

2. Background Information

The majority of the U.S. population has some form of medical insurance coverage, which covers and pays for most all medical treatments and services. The typical medical insurance coverage transaction involves payment of a doctor's and/or hospital's bills after the actual treatment and/or service has been provided. The process and currently used system causes myriad problems and issues regarding pending payments, validity of the medical coverage, etc.

Typically, medical organizations periodically issue their customers/members a PVC card on which phone numbers and the address of the issuance provider are printed. At present, medical insurance providers in the U.S. communicate with physicians, hospitals and pharmacies about coverage, payments and or other issues mostly via telephone, faxes and hard copy letters. Most interchange of patient information, payment issues, coverage and related topics are “off line.” An organization providing the medical treatment, pharmaceutical distribution, and health service usually calls the provider for verification. Some information is directly printed on the card. This, however, is forgeable and validity of the ID card is difficult. Regulations of HIPAA (Health Insurance Portability and Accountability Act), the ruling U.S. agency in the health and medical regulatory sector, instruct all medical offices to be online compatible by October 2002. Thus, the need exists for techniques that effectively and efficiently modernize health care insurance/pharmaceutical transactions and administration.

### SUMMARY

According to the present invention, a personalized smart card is encoded with patient information, including identification information, and a Uniform Resource Locator (URL) of an insurance provider's and/or pharmaceutical service provider's extranet or a web site to facilitate health care insurance/pharmaceutical transactions and administration. According to an aspect of the present invention, a computer-implemented method uses such a personalized smart card to navigate to an insurance provider's and/or pharmaceutical service provider's extranet or a web site to provide users (e.g., physicians, nurses, hospitals, pharmacies, etc.) with an easy way to access, verify, and update information needed to determine insurance coverage and other patient information and to accurately determine/submit pharmaceutical prescriptions. In one implementation of the present invention, the personalized smart card contains one or more integrated circuit chips with a computer-readable memory that is encoded with a patient's vital statistics and a URL of an insurance provider's and/or a pharmaceutical service provider's extranet or a web site.

In one implementation of the present invention, the user (e.g., doctor, nurse, hospital, pharmacy, etc.) inserts the medical ID smart card into a smart card reader that is connected to a computer or other computing device capable of accessing the public web or a private extranet. In response to the insertion of the smart card into the smart card reader, application specific software is launched. The program immediately displays important medical statistics of the patient. Web browser or extranet browser software is launched to automatically navigate to the medical insurance provider's and/or pharmaceutical service provider's URL or an extranet site. When the browser is launched to navigate to a medical insurance provider's URL/extranet site, the medical insurance provider's policy, rules, and coverage are posted. When the browser is launched to navigate to a pharmaceutical service provider's URL, the user may access information indicating, e.g., which medications are covered by the patient's insurance, the patient's pharmaceutical history, potential interactions/adverse affects of different drugs, whether a medication covered by the patient's health care plan may be substituted for the one the physician plans to prescribe, etc., and/or to electronically submit a pharmaceutical prescription.

In accordance with the present invention, the user may automatically review data and navigate to the encoded URL simply by inserting the smart card into the smart card reader, without having to type any information, use the computer's mouse, or provide any other user input. When the user inserts the medical ID smart card into the smart card reader, patient health information and data stored on the smart card may be read as well as an extent of the medical coverage.

One particularly advantageous implementation of the present invention utilizes smart cards that have one or more contactless integrated circuit chips that include an antenna coil formed directly on the surface of the chip. Such a chip, called “Coil-on-Chip,” has been developed by Maxell and is particularly useful in the medical ID smart card of the present invention because of improved durability and low cost. Two specific exemplary implementation options for the medical ID smart card of the present invention are:

1) a medical ID smart card with one Coil-on-Chip (a standard PVC card with one embedded chip—for exemplary details refer to Appendix A of U.S. Provisional Application No. 60/308,106); and

2) a medical ID card with two Coil-on-Chips (a standard PVC card with embedded two chips—for exemplary details refer to Appendix B of U.S. Provisional Application No. 60/308,106).

### BRIEF DESCRIPTION OF DRAWINGS

Other aspects and advantages of the present invention will become apparent upon reading the following detailed description and upon reference to the drawings, which are provided for illustration purposes only and should not be deemed to limit the scope of the present application, in which:

FIG. 1 is a block diagram illustrating an exemplary system for implementing principles of the present invention;

FIG. 2 illustrates, in more detail, one implementation for the exemplary system of FIG. 1;

FIG. 3 is a flow diagram illustrating functions of an implementation of the present invention for using a medical ID smart card to retrieve information from an extranet site or public web site set up by a medical service provider/card issuer;

FIG. 4 is a flow diagram illustrating functions of an implementation of principles of the present invention to retrieve additional information from a medical ID smart card; and

FIGS. 5A-5B illustrate an exemplary medical ID smart card in accordance with principles of the present invention.

### DETAILED DESCRIPTION

The present invention facilitates health care insurance transactions, pharmaceutical services, and administration by providing a personalized smart card that is encoded with patient information, including patient identifying information, and a Uniform Resource Locator (URL) of an insurance provider's and/or a pharmaceutical service provider's extranet or a web site. Such a smart card is referred to herein as a “medical ID smart card.”According to an aspect of the present invention, a computer-implemented method automatically navigates to a web site or a health insurance provider extranet site using the medical ID smart card to provide users (e.g., physicians, nurses, hospitals, pharmacies, etc.) with an easy way to access, verify, and update information needed to determine insurance coverage and other patient information. For this purpose, the medical ID smart card contains a computer-readable memory that is encoded with a Uniform Resource Locator (URL) of the web or extranet site. According to another aspect of the present invention, a computer-implemented method uses the medical ID smart card to automatically navigate to a pharmaceutical service provider's extranet/web site to provide the user with pharmaceutical information and services, such as allowing the user to access information indicating, e.g., which medications are covered by the patient's health care plan, the patient's pharmaceutical history, potential interactions/adverse affects of different drugs, whether a medication covered by the patient's health care plan may be substituted for the medicine the physician plans to prescribe, etc., and/or to electronically submit a pharmaceutical prescription.

The invention may be used by medical insurance providers, hospitals, physicians, pharmacies, government agencies, non-profit organizations, and other enterprises to provide customers, members, and other individuals with easy access to the enterprise's web or extranet for health insurance coverage, pharmaceutical services, and other related purposes. The medical ID smart card will also contain medical data for individual patients, members and other ID card holders.

The enterprise may be a card issuer and may:

Encode a personal patient code for each individual cardholder.

Encode vital medical data, permanent (read-only) and temporary (read & write).

Encode its extranet or/and web site's URL on a smart card.

Design print of the surface of the smart card, such as graphics and text content.

Select one chip or multiple (e.g., two) chip medical ID card design.

Because both the medical ID smart card and the process of encoding information on the medical ID smart card are relatively inexpensive, thousands of such smart cards may be manufactured relatively inexpensively and provided to many enterprises and individuals at low cost.

Medical insurance providers may issue medical ID smart cards to patients and insurance members, and also distribute a smart card reader to hospitals, physicians and pharmacies. Timely distribution and low cost of a particular model of a medical ID smart card and smart card reader may help to encourage the widespread adoption of those models of smart card and smart card reader.

The medical ID smart card manufacturer will make cards to issuers' specifications with encoding of the relevant URL (e.g., the insurance company's URL) onto the medical ID smart card and, optionally, physically imprinting the insurance provider's/pharmaceutical service provider's logo and/or other information on the face of the medical ID smart card. The card issuer, which in most instances will be the insurance provider, may encode personal data and information onto the medical ID smart card for each individual cardholder.

In a further embodiment of the present invention, the URL-encoded smart card contains personalized information tailored to the issuer and the owner of the smart card. For example, the medical ID smart card may contain a unique user ID identifying the owner of the smart card. The incorporation of such identifying information on the medical ID smart card may be used to enable various applications, such as tracking individual medical treatment, medication prescriptions and use of the owner of the medical ID smart card. Furthermore, the medical insurance providers may use the personalized information stored on the medical ID smart card to direct personalized medical care instructions for physicians, hospitals and pharmacies.

It should be appreciated that the various features of the present invention described above and described in more detail below provide numerous advantages. For example, medical enterprises and their administrative employees currently devote a significant portion of their workday to verifying patient's data over the phone and to sending and receiving faxes, as well as typing letters and e-mails to health enterprises who pay the bills. While using the medical ID card, telephone calls to the provider and endless faxing may be totally eliminated. The medical ID smart card may also minimize keyboard typing and inevitable typing mistakes. Furthermore, insertion of a medical ID smart card into a smart card reader or other appropriate device may be easier for users with physical disadvantages than typing or clicking.

Organizations may gradually replace their existing cards with medical ID smart cards in a manner that is minimally disruptive to card holders and the medical community. The card replacement may be orchestrated on geographical area bases. Such a practice is likely to meet with little resistance by the cardholders and the health enterprises.

As with currently issued insurance cards, the insured person carries the medical ID smart card with him/her. When entering a hospital and checking in, a nurse, doctor, pharmacist or other medical personnel may use a reader/writer and PC to review immediately the actual medical data stored on the card and also to navigate to the medical insurance provider dedicated web site/extranet. This may facilitate an instant verification of the medical insurance coverage and eliminate ongoing disputes between an insurance provider, doctor and the patient.

Current telephone and fax verification of medical coverage is slow and outdated. The supplier of a medical treatment often faces eventual disputes about payments for the given service especially in emergency situations. Medical organizations and insurance providers employ myriad collecting agencies to secure their payments. If, for example, the doctor used the medical ID smart card and found from the medical insurance provider extranet/web site that the medical coverage for the patient has expired, he/she can make an instant decision about an appropriate medical service and there would be no uncertain payment issue left for the future. The medical or health enterprise expense for payment-collecting agencies will be virtually eliminated.

At present, hospitals and doctors are flooded with paperwork and telephone calls, large volumes of medical documents being processed every day. By the nature of the medical ID smart card invention, the present labor intensive system may be changed and fewer administrative personnel may be required in the health industry sector. The insured individuals can easily carry the medical ID smart card in their wallets every day. Such a method of a personal ID, combined with the encoding of the issuer URL on the medical ID smart card for use in a variety of health organizations represents an improvement over existing techniques for health and medical personal identification. Furthermore, unlike conventional printed ID cards which rely on telephone and fax communication, the medical ID smart guarantees a seamless twenty four hour access to selected medical records and insurance coverage, as well as a list of medications covered by the health insurance provider. Currently, communication via telephone and fax is sometimes limited to work days and work hours. At present, medical coverage information during weekends and holidays is an issue in some cases.

A further problem faced by the health service community is that an analog telephone and typed hard copy communication may result in incorrect data for a particular individual. The medical ID smart card of the present invention addresses this problem because digital data transfer and no type, no click smart card operation will result in an obtainment of an accurate medical data for each individual. This may result in fewer human mistakes and it may correspond to fewer legal proceedings between hospitals, physicians, patients and health insurance providers. This advantage may represent significant savings for legal and administrative fees. Freed funds can be used against the costs associated with the medical ID smart card implementation.

One particularly advantageous implementation of the present invention utilizes smart cards that have one or more contactless integrated circuit chips that include an antenna coil formed directly on the surface of the chip. Such a chip, called Coil-on-Chip, has been developed by Maxell and is particularly useful in the medical ID smart card of the present invention because of improved durability and low cost. Details of Maxell's Coil-on-Chip technology are provided in PCT application PCT/JP00/01029, the entire contents of which are herein incorporated by reference.

Two specific exemplary implementation options for the medical ID smart card of the present invention are:

1) a medical ID smart card with one Coil-on-Chip (a standard PVC card with one embedded chip—for exemplary details refer to Appendix A of U.S. Provisional Application No. 60/308,106); and

2) a medical ID card with two Coil-on-Chips (a standard PVC card with embedded two chips—for exemplary details refer to Appendix B of U.S. Provisional Application No. 60/308,106).

In the one chip implementation (e.g., 108 bytes, 1 kbytes, 2 kbytes, or 4 kbytes of memory), the memory chip may include both permanent patient data (e.g., name, social security number, insurance number, blood type, allergies, URL for service provider/card issuer, etc.) and temporary data (e.g., current medications, diagnoses, next scheduled visit, treatment, etc.). In the multiple chip implementation, a first chip may be used to store permanent patient data (read-only), and a second chip may store temporary patient data (read and write).

Health insurance enterprises (the providers) may take advantage of the inexpensive medical ID smart card. Advantageous features of the digital data transfer and information reception may encourage physicians and pharmacies to accept and to prefer the e-compatible insurance provider policy. Providers may acquire wider geographical coverage while their day-to-day operation expense may decline. Due to the personal data transfer automation, less wages may be required for health industry administrative personnel.

### Applications

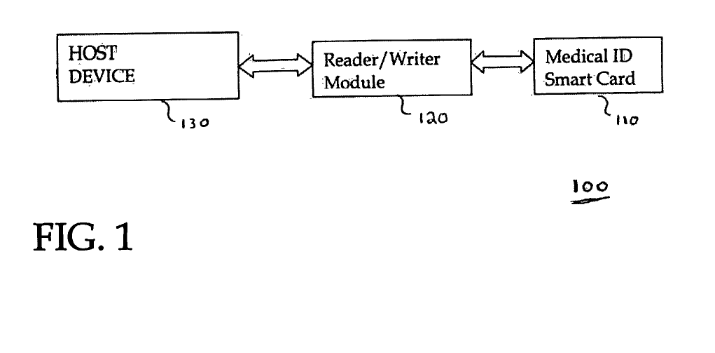

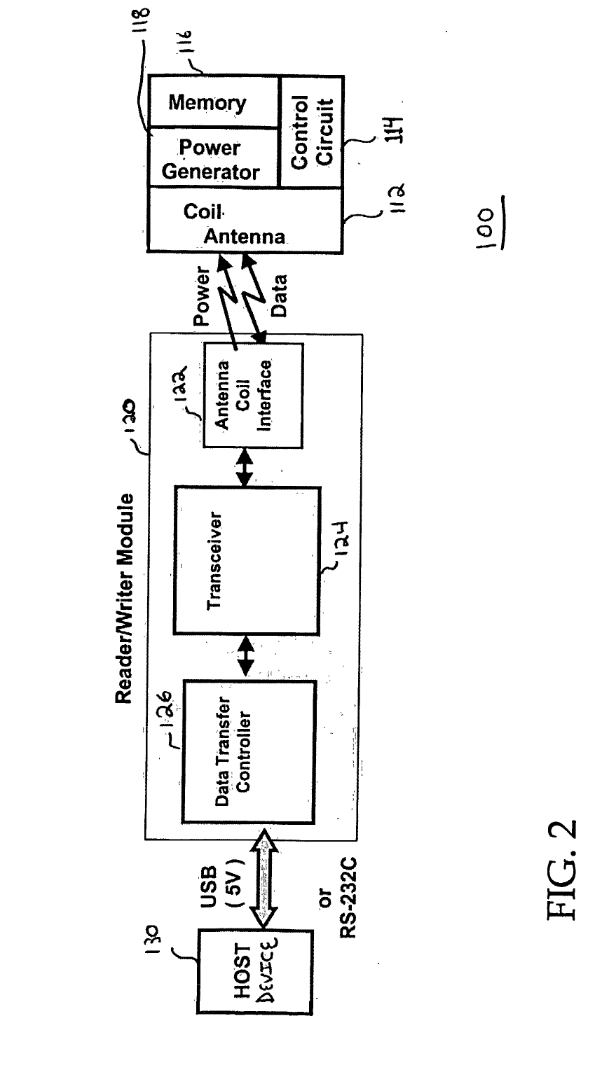

According to one application of principles of the present invention to medical health insurance transactions and administration, a basic medical ID smart card system includes media (i.e., contained in the medical ID smart card itself), a reader/writer, a host/PC, and a remote server (e.g., connected to a TCP/IP network such as the internet). An exemplary medical ID card system illustration is provided in FIG. 1, in which the system 100 includes: a medical ID smart card 110; a reader/writer module 120; and a host device 130 connected to the reader/writer module 120. In the system 100 of FIG. 1, the reader/writer module reads information from the smart card 110, for example to retrieve permanent and/or temporary patient data. As illustrated in FIG. 2, the smart card 110 may include one or more “Coil-on-Chip” contactless integrated circuit chips having an antenna coil 112, a control circuit 114, a memory 116, and a power generator 118. As also illustrated in FIG. 2, the reader/writer module 120, which may be a Pichochet™ reader/writer from Maxell, may include an antenna coil interface 122 and a transceiver 124 for reading data from/writing data to and providing power to the smart card 110, and a data transfer controller 126 for receiving data from/transferring data to the host device 130. The host device 130 may be for example a PC with a USB or RC-232C connection to the reader/writer module 120 and is connected to a computer network, e.g., the Internet, so as to connect to an extranet site or public web site of the card issuer/service provider.

In the present invention, the medical ID smart card may be encoded with personalized information that is tailored to and/or identifies the user and the issuer of the medical smart card. Such information may be automatically transmitted to the extranet or web site by the host device 130 and advantageously be used to personalize the content of the insurance member information. For example, the user's user name may be automatically transmitted to the web or extranet site, and web site's or extranet site's contents may be selected and/or personalized based on the provider's preferences, medical history, or demographic information. This functionality of the system may follow HIPPA regulations and professional practice.

Conventional techniques may be used to verify medical insurance coverage when a card reader/writer is not available at the medical service provider such as physician's office, hospital, pharmacy or other enterprise. Medical insurance telephone numbers may be printed on the medical ID smart card.

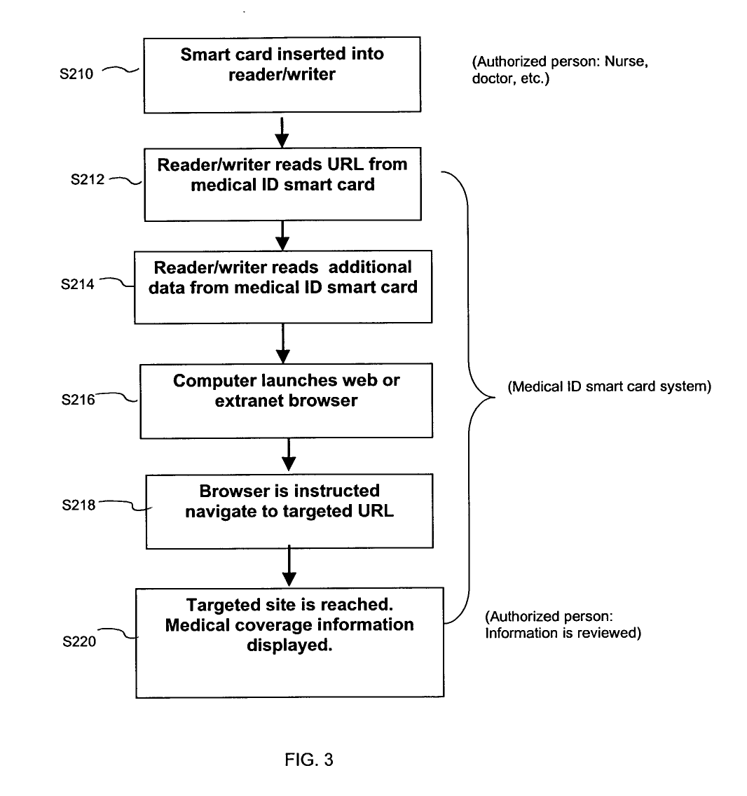

Various aspects, features, and characteristics of this application of the present invention will be described in more detail below. An exemplary implementation of principles of the present invention is illustrated in the flow chart of FIG. 3. Referring to FIG. 3, a diagram is shown that illustrates an exemplary flow of functions of the invention to view the health insurance provider policy and regulation on extranet or private web site.

Data transfer and communication starts by inserting a the medical ID smart card 110 into a card reader/writer module 120 (Step S210). Reader/writer module 120 reads the media of the medical ID smart card 110 and, via browser software of the host device 130, the encoded extranet or a web site location is found on a remote server. More specifically, the reader/writer module 120 reads a URL from the smart card 110 (Step S212) and also reads any necessary additional data from the smart card (Step S214). Upon receiving URL information from the reader/writer module 120, the host device 130 may automatically launch a web/extranet browser (Step S216) and navigate to the targeted URL (Step S218). Upon connecting to the targeted site indicated by the URL, the user of the host device 130 may access information (e.g., medical coverage information) from the targeted site (Step S220). Before viewing such information, the user may be required to confirm authorization for viewing the information. A conventional system may be employed to transmit information between a web/extranet client and web/extranet server over a TCP/IP network. The medical ID smart card 110 communicates with the reader/writer 120 and the reader/writer module 120 interfaces with the host device 130. A browser of the host device 130 may generate a request for the extranet or web page according to the Hypertext Transfer Protocol (HTTP).

As discussed above, the system 100 may use a process to automatically navigate to the web site. When the user inserts the medical ID smart card 110 into the reader/writer module 120, the reader/writer module 120 detects that the medical ID smart card 110 has been inserted into and reads the encoded URL from the medical ID smart card 110.

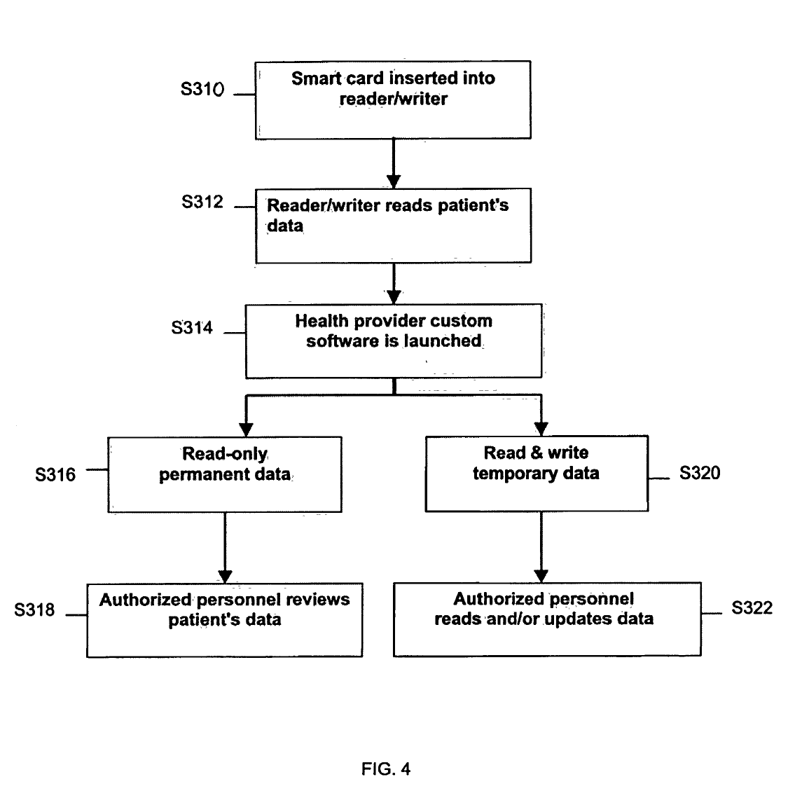

FIG. 4 illustrates an exemplary method of reading any additional information from the smart card 110, such as a user name, medical insurance information, health data, etc. User access may be limited to selected and dedicated personnel, health industry professionals, or organizations that retain a medical card reader/writer. Technical provisions may be made by the medical ID smart card system issuer that only authorized personnel can access the system. The reader/writer and the card chip may contain permanent encryption that no other reader/writer can be used to enter the medical ID smart card data or non-authorized person cannot access the patients' records on a remote server or on the card media. In the process for reading additional information from the smart card 110 illustrated in FIG. 4, the medical ID smart card 110 is inserted into the card reader/writer module 120 (Step S310) and the reader/writer module 120 reads patient data from the card (Step S312). The host device 130, upon determining that a card is being read by the reader/writer module 120, launches software for accessing data from the card (Step S314). Specifically, the host device 130 instructs the reader/writer module 120 to retrieve permanent data (Step S316) and also may instruct the reader/writer module 120 to read/write temporary data from/to the smart card 110 (Step S320). Before accessing permanent data and/or temporary data, the user of the host device 130 may be required to establish authorization, thus permitting authorized personnel to review patient data and/or change temporary data stored on the card (Steps S318 and S322).

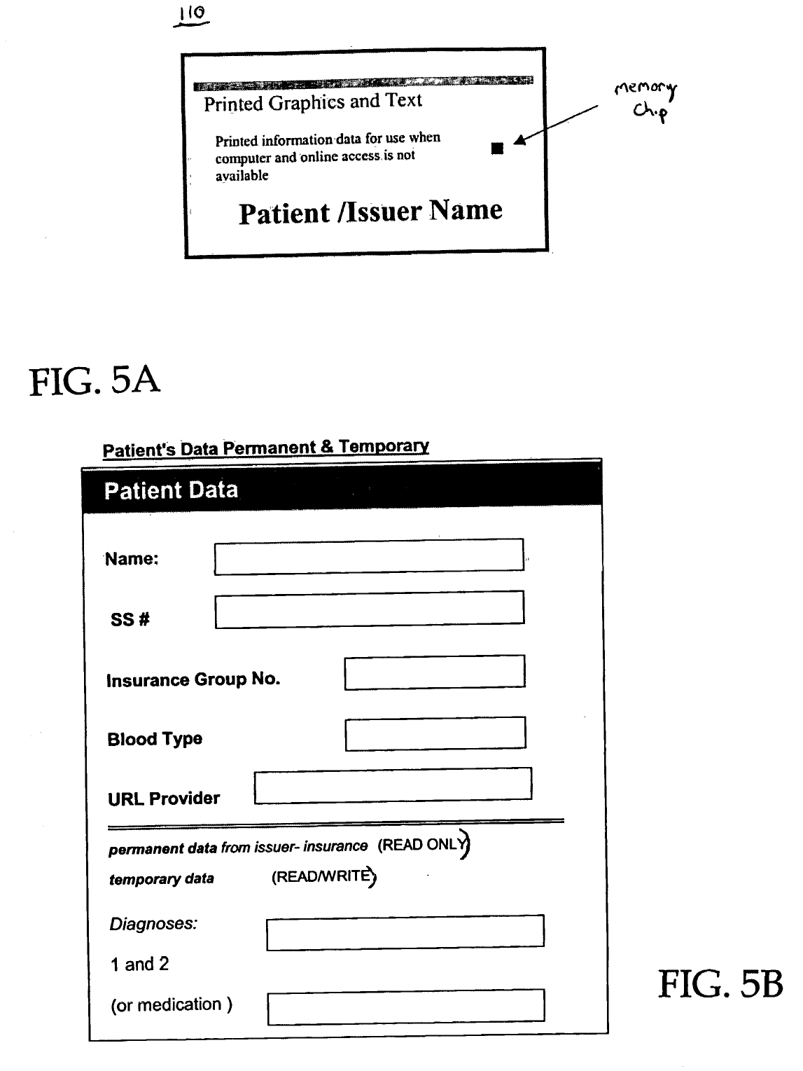

The medical ID smart card 110 implementation of FIG. 2 includes an integrated circuit that includes a memory module 116 for storing information. Stored in the memory module 116 is patient's data and URL. It should be appreciated that a variety of information may be stored on the medical ID smart card—for example, an access to a medical or health organization database. FIGS. 5A and 5B illustrate an exemplary medical ID smart card 110 in accordance with principles of the present invention. As shown in FIG. 5A, the exterior of the medical ID smart card 110 may include printed graphics and text, including the patient's name and service provider's name (e.g., insurer's name in the case of an insurance card). As shown in FIG. 5B, the memory of the medical ID smart card 110 may include both permanent and temporary information. As shown in FIG. 5B, the permanent data may include patient name, social security number, insurance group number, blood type, and URL for the service provider. The temporary data stored on the medical ID smart card 110 may include diagnosis information, as well as medications for the patient.

Again, the principles of the present invention may advantageously be implemented using new integrated circuit contactless chip technology that has been introduced as Coil-on-Chip by Maxell. Such an implementation is economical and, thus, an individual can carry the medical ID smart card in a wallet and any doctor's office or a hospital with a PC or other computer device can connect easily a smart card reader/writer as a computer peripheral. The Coil-on-Chip smart card does not require contact with the card reader/writer reading device. The chip is inside of the card—it is embedded in the plastic. Unlike common contact IC cards, the Coil-on-Chip smart card and the embedded chip cannot be damaged. The chip does not peel off from the PVC card surface. Wear and tear is the major disadvantage for the contact IC chips presently offered in smart cards. The Coil-on-Chip smart cards are durable and applicable for frequent usage such as carrying ID card in a wallet, packet, etc.

This invention and the above-described microchip card technology will result in a less labor intensive operation and decrease costs associated with the current enormous administrative system. Fewer mistakes will be made, which is an important factor for the medical field. Better and quicker medical services will be the final outcome of the medical ID smart card system.

The health insurance provider web or extranet site may deny user's (hospital, doctor, pharmacy) access to the medical records of an individual with the medical ID card. If the patient's medical insurance coverage has expired or was canceled, the particular patient records may not be available online. For example, this may provide an instant verification of the medical insurance coverage, instead of an insurance policy display on the screen of PC there may be a warning sign indicating that the coverage is no longer available. In the majority of cases in the U.S., medical insurance is offered to individuals by their employers. When employment of an employee is ceased for any reason, the person's medical coverage is either canceled or continues for a limited time. The present, no microchip health insurance card, remains in the former employee possession. A hospital or physician may accept this no longer valid card and then have payment issues later after the treatment.

When the medical ID smart card of the present invention is used, and access to the verification web site is denied, users (doctor, hospital or other dedicated personnel) may have a chance to contact the insurance company via telephone and it may be the physician's decision about treatment or medication when medical coverage is not confirmed. It should be appreciated that an instant ID validity may be available by enabling this particular online access functionality of this invention. The new system of instant medical coverage verification may save hospital and doctors' funds for after the fact administrative efforts to get payments for services already provided. Funds from these cost savings may be applied against the medical ID smart card system hardware and software on the hospital or physician's business side.

The smart card reader may be any device that is capable of accessing information on the smart card and transmitting such information to the client computer. The smart card reader may be capable of reading information from the smart card, writing information to the smart card, or both. The smart card reader may be a contact smart card reader or a contactless smart card reader, as appropriate. The smart card reader may be connected to the client computer using any form of connection, such as a serial cable, parallel cable, Universal Serial Bus (USB) cable, or wireless connection.

As described above, the smart card reader driver enables communication between the smart card reader and the client, medical insurance provider, and computer. The smart card reader driver may be implemented in any manner to transmit information to and/or to read information from the smart card reader on behalf of the client computer. Once software installed, the smart card reader driver provides an Application Program Interface (API) through which application programs, such as medical data specific software and/or the web browser launcher, may communicate with the smart card reader.

The host of the smart card system can be a computer or device incorporating a computer processor, such as a desktop computer, laptop computer, etc. The web or extranet browser may be any web browser or other HTTP client and may be implemented in hardware, software, firmware, or any combination thereof.

The TCP/IP network used to exchange information between the host computer and the accessed server may be any network, internet (such as the public Internet), intranet, extranet, subnetwork, or combination thereof that is capable of transmitting communications according to TCP/IP. The web browser or extranet browser and the server may be connected to the TCP/IP network in any manner, such as by standard analog telephone lines, optical fiber, or a wireless network.

Another application of the principles of the present invention relates to pharmaceutical services. In this application, the medical ID smart card is also/alternatively encoded with the URL for an extranet/web site of a pharmaceutical service provider. When the browser is launched to navigate to the pharmaceutical service provider's URL, the user may access information indicating, e.g., which medications are covered by the patient's insurance, the patient's pharmaceutical history, potential interactions/adverse affects of different drugs, whether a medication covered by the patient's health care plan may be substituted for the one the physician plans to prescribe, etc., and/or to electronically submit a pharmaceutical prescription. In this way, the process of prescribing drugs is facilitated and accuracy (i.e., safety) may be improved.

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly involved in a machine-readable storage device for execution by a computer processor. Method steps of the invention may be performed by a computer processor executing a program tangibly embodied on a computer-readable medium to perform functions of the invention by operating on input and generating output.

It is to be understood that although the invention has been described above in terms of particular basic concept, the foregoing embodiments are provided as illustrative only, and do not limit or define the scope of the invention. Other embodiments are also within the scope of the present invention, which is defined by the scope of the claims below. Other embodiments that fall within the scope of the following claims includes include, but are not limited to, the following.

What is claimed is:

1. A computer-implemented method comprising steps of:
(A) storing, writing and encoding data related to a health insurance customer/subscriber onto a portable computer-readable medium, as well as, retrieving a Uniform Resource Locator from said portable computer-readable medium; and
(B) reviewing stored media data and navigating a web browser to a data base or a web site that provides medical insurance and/or pharmaceutical service information for said health insurance customer/subscriber without requiring user input.

2. The method of claim 1, wherein the portable computer-readable medium is a medical ID smart card

3. The method of claim 2, wherein the medical ID smart card includes a contactless integrated circuit chip with a coil antenna formed directly on a surface of the chip.

4. The method of claim 1, further comprising steps of:
(C) detecting accessibility of the portable computer-readable medium to a device for accessing the portable computer-readable medium; and
(D) performing the steps (A) and (B) in response to said detection.

5. The method of claim 1, further comprising a step of:
(C) reading additional information from the portable computer-readable medium; and
(D) transmitting the additional information to the web or extranet site.

6. The method of claim 5, wherein the step (C) comprises a step of reading information descriptive of a user of the portable computer-readable medium from the portable computer-readable medium.

7. The method of claim 6, wherein the information descriptive of the user involves a user name.

8. The method of claim 7, further comprising a step of:
(E) providing the user name to a database or a web site without requiring user input.

9. The method of claim 6, further comprising steps of:
(E) determining whether the user has access privileges to the web or extranet site based on the information descriptive of the user;
(F) granting the user access to the web site if the user has access privileges to the web site; and
(G) denying the user access to the web site if the user does not have access privileges to the web site.

10. The method of claim 6, wherein the information descriptive of the user comprises medical data provided by the web or extranet site.

11. The method of claim 6, further comprising steps of:
(E) selecting content to display to the user based on the information descriptive of the user; and
(F) displaying the selected content to the user.

12. The method of claim 5, further comprising a step of:
(E) modifying the additional information on the portable computer-readable medium.

13. An apparatus comprising:
means for retrieving permanently and temporarily stored data relating to a medical insurance customer/subscriber and a Uniform Resource Locator from a portable computer-readable medium; and
means for navigating to a certain database and/or a web browser to a web site specified by the Uniform Resource Locator that provides medical insurance and/or pharmaceutical service information for said health insurance customer/subscriber without requiring user input.

14. The apparatus of claim 13, wherein the portable computer-readable medium is a smart card.

15. The apparatus of claim 14, wherein said smart card includes a contactless integrated circuit chip with a coil antenna formed directly on a surface of the chip.

16. The apparatus of claim 13, further comprising:
means for detecting accessibility of the portable computer-readable medium to a device for accessing the portable computer-readable medium; and
means for performing the steps (A) and (B) in response to said detection.

17. The apparatus of claim 13, further comprising:
means for reading additional information from the portable computer-readable medium; and
means for transmitting the additional information to the web site.

18. The apparatus of claim 15, wherein said smart card includes a second contactless integrated circuit chip with a coil antenna formed directly on a surface of the chip.

19. The method of claim 3, wherein the medical ID smart card includes a second contactless integrated circuit chip with a coil antenna formed directly on a surface of the chip.
